(19) United States
(12) Patent Application Publication
(10) Pub. No.: US 2023/0186785 A1
(43) Pub. Date: Jun. 15, 2023

(54) MULTI-MODAL LEARNING PLATFORM

(71) Applicant: Yumcha Studios Pte Ltd, Singapore (SG)

(72) Inventor: Yen Yen Joyceln WOO, Taipei City (TW)

(21) Appl. No.: 17/921,106

(22) PCT Filed: Apr. 21, 2021
(86) PCT No.: PCT/SG2021/050226

§ 371 Date: Oct. 24, 2022

Related U.S. Application Data
(60) Provisional application No. 63/013,563, filed on Apr. 22, 2020.

(51) Int. Cl. G09B 19/06; G09B 7/02; G09B 5/06

(52) U.S. Cl. CPC G09B 19/06; G09B 7/02; G09B 5/06

(57) ABSTRACT

A method and system that provides a learning experience for language study through an interactive learning platform. In one embodiment, the learning platform is a multi-modal language learning platform configured to provide bilingual or multilingual training The learning system strengthens language learning through the interplay between the mutually reinforcing effects of illustrated stories (comic stories), translanguaging, drawing video sessions and reading aloud.

### CROSS-REFERENCE TO RELATED APPLICATION

This application claims the benefit of U.S. Provisional Application Ser. No. 63/013,563, filed on Apr. 22, 2020. The disclosure is herein incorporated by reference in its entirety for all purposes.

### FIELD OF THE INVENTION

The present invention is generally related to pedagogical approaches to provide interactive learning. More specifically, the present invention is directed to systems and methods of providing a multi-modal learning environment equipped with a combination of diversified learning content and various interactive functionalities to achieve a creative and effective learning experience.

### BACKGROUND

Accelerated globalization and its associated technological advancements have led to a closely interconnected and networked world today. For example, the development and deployment of technological social networking systems and the possibility of instant reach to information, particularly, in a wireless environment, has changed the way people learn and communicate today. As an impact of globalization, there is increasing demand for fluency and literacy in a variety of languages to meet the need for transnational communication in the social and/or economic context.

However, learning a foreign, second, or new language is often a challenging feat. Learners are easily discouraged during the learning process. In addition, the current techniques which rely on textbooks, exams and pure memorization do not help to encourage or motivate the learners to overcome the challenges faced.

From the foregoing discussion, there is a need to provide for a learning system which creates a learning experience which motivates learning through combining interactive learning with social interaction to encourage the holistic development of, for example, language skills during learning activities.

### SUMMARY

The present disclosure describes exemplary pedagogical approaches to facilitate a multi-modal learning environment equipped with a combination of diversified learning content and various interactive functionalities to achieve a creative and effective learning experience. For example, the present disclosure provides learners with a more interesting learning environment, enabling learning using a holistic approach. For example, providing a learning system which is directed towards not just the technical aspects of, for example, learning a target language by listening, reading, writing, speaking, pronunciation, grammar, vocabulary but also to create associations of enjoyment and creativity with the target language.

The disclosed example systems and methods may be more effective than conventional language learning and teaching methods.

In one embodiment, a method for language learning on a learning platform includes providing the learning platform which includes a backend system executed on a server. The backend system includes a reading module which is configured to manage programs including providing language programs. The language programs employ translanguaging techniques for training a target language. The learning platform also includes a frontend system executed on a user device and the frontend system includes a user interface to access various modules of the backend system. The method further includes training of a language program selected by a user accessing the reading module through the user device. The selected language program is presented based on a user native language input and a user target language input. The method also includes assessing performance of the user during training of the selected language program including performing analytics using a speech analysis module of the backend system to provide feedback on language fluency and pronunciations of the user.

In another embodiment, a learning platform for language learning includes a backend system executed on a server and the backend system includes a reading module which is configured to manage programs including providing language programs. The language programs employ translanguaging techniques for training a target language and the language programs are presented based on a user native language input and a user target language input. The backend system also includes a speech analysis module configured to assess language fluency and pronunciations during training of the language programs. The platform further includes a frontend system which is executed on a user device and includes a user interface to access various modules of the backend system.

In yet another embodiment, a method for multi-modality language learning includes selecting a target language and a native language by a user, providing the user with a selection of translanguage reading documents configured with the target language and the native language, selecting by the user a selected reading document for reading, displaying the selected reading document for the user to read aloud into a microphone for recording a recorded reading by the user of the selected reading document, and assessing a performance of the user based on the recorded reading using speech analysis to provide feedback on language fluency and pronunciation of the user.

These and other advantages and features of the systems and methods herein disclosed, will become apparent through reference to the following description and the accompanying drawings. Furthermore, it is to be understood that the features of the various implementations described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various implementations. In the following description, various implementations of the present disclosure are described with reference to the following, in which:

FIG. 1 shows an embodiment of a framework for a learning system;

FIG. 2 illustrates an embodiment of a framework involving an App of the learning system;

FIGS. 3a-3c show various exemplary pages or views of a learning platform;

FIGS. 4a-4b show various program section views of a program overview page within the learning platform;

FIG. 5a shows an embodiment of a program homepage of a selected

program;

FIGS. 5b-5d show various exemplary pages or views of the platform in different stages of modifying program settings of a selected language program;

FIGS. 6a-6d show various scenario views of a storytelling session in a selected language program;

FIGS. 7a-7c show various scenario views of the storytelling session;

FIG. 8 shows a process flow of a voice practice session in the selected language program;

FIGS. 9a-9d show various views of another activity page of the voice practice session;

FIG. 10 shows a section page of the voice practice session;

FIGS. 11a-11f show various scenario views of a game session in the selected language program;

FIGS. 12a-12c show various scenario views of another game session in the selected language program;

FIG. 13 shows a live video session published on the learning platform; and

FIGS. 14a-14b show resources published on the learning platform.

### DETAILED DESCRIPTION

A framework for an interactive learning system and method is described herein. In particular, the present disclosure relates to a learning system and method that integrates live online learning and self-paced learning within a learning platform.

In one embodiment, the learning platform allows users, for example, learners, to access content including digitalized content and/or print form maintained in the platform at any time. The learning platform provides training activities containing learning content that are interactive, thereby encouraging the learners to be actively involved in the learning process; and constructive, assisting knowledge building process.

In one embodiment, the framework involves learning languages using content contained in the learning platform. For example, the framework includes providing courses such as language programs to train learners to be bilingual or multilingual. A language program, for example, may be conducted in two or more languages at one time. Different types of language programs adapted for different purposes may be provided. For example, language programs with different levels of difficulty, different learning objectives, or for different age groups may be provided by the platform. The programs or courses may also be topic-dependent. For example, providing courses focusing on topics or fields other than languages may also be possible. For example, sciences, mathematics, arts, humanities, or other fields may be included.

When enrolled in a course, the learners are exposed to a variety of learning activities with multimodal media content that stimulate the learners' cognitive learning. For example, in the case of a language program, learners are encouraged to engage their visual and auditory senses as well as exercise their speech capabilities to achieve a more effective learning experience. In one embodiment, the digital learning platform is configured to support independent learning. For example, the platform evaluates and records a learner's performance after training of a course so that the learner is aware of his competence level without requiring external aid from a teacher or mentor.

Additionally, the learning platform may provide other relevant resources to guide and support the learners. For example, the relevant resources may include supporting resources for learners, such as quizzes, exercise or activity sheets, feature articles as well as teaching resources for trainers such as lesson plans.

The system, in one embodiment, combines interactive learning through digital games, stories (in both print and digital form), videos, curricular support materials, which are accessible through Apps and web Apps as well as other avenues, to provide a multi-modal learning environment for a creative and effective learning experience.

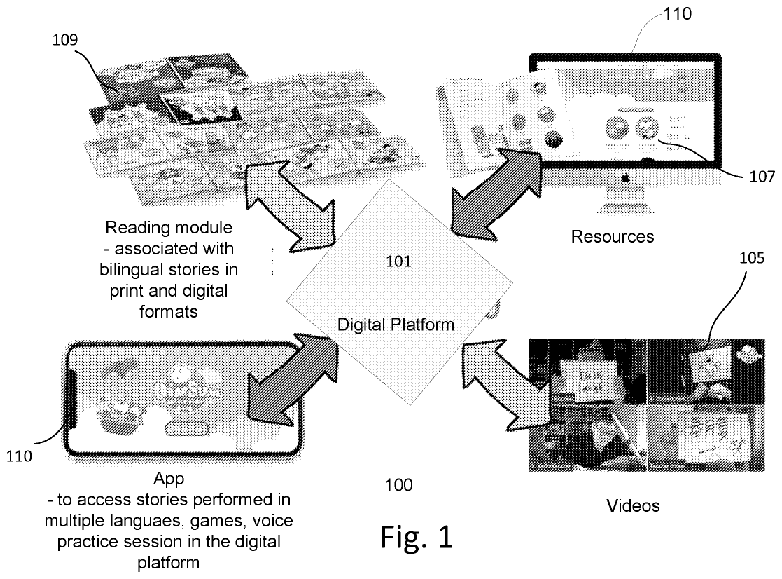

FIG. 1 shows a simplified embodiment of a language learning system 100 with a digital language learning platform 101. In one embodiment, the learning system is a multi-modal language learning system. As shown, the system serves as a framework that integrates a pool of diversified learning content with various functionalities to form a multi-modal language learning system.

In one embodiment, the system includes a software application. The software application, for example, is a distributed software application with a frontend portion and a backend portion. The frontend portion may reside on a user device 110, such as a mobile phone, a tablet computer, a laptop computer or a desktop computer. Other types of user devices may also be useful. The backend portion, for example, resides on a server or servers. The server may be a cloud or a private server.

In one embodiment, a communication network communicatively connects the frontend and backend. The communication network, for example, may include, one or more communication networks of any suitable type in any combination, including wireless networks (e.g., WI-FI network), wired networks (e.g., Ethernet network), local area networks (LAN), wide area networks (WAN), personal area networks (PAN), mobile radio communication networks, the Internet, and the like. Furthermore, the network may include one or more network topologies, including a bus network, a star network, a ring network, a mesh network, a star-bus network, a hierarchical network, and the like. It should be appreciated that the server may also be in communication with other remote servers or various client devices through other networks or communication connections.

The frontend portion, for example, may be considered a mobile application (App) installed on the user device. When initiated on the user device, the App accesses the backend portion on the server. The App, for example, may be a native or a hybrid App which can access features of the user device. For example, the App can access the user device's microphone, camera, as well as other native features. Alternatively, the App can be a web-based App, accessing the backend portion through a web browser.

The App includes a user interface (UI) which is displayed on the user device. For example, the UI displays on the user device when the App is initiated. To access the App, the user may log in to the platform using a username and password. The UI helps the user to navigate the platform.

The platform, in one embodiment, includes a reading module 109, a video module 105 and a resource module 107. The modules, for example, are part of the backend portion. The user may access the various modules of the learning platform through the App. In one embodiment, the platform is tailored for children to learn languages. Although the platform is tailored for children, it can also be applied to learning languages for people of all ages.

In one embodiment, the reading module contains digitized content for reading. The digitized content includes reading materials such as bilingual or multilingual reading materials. For example, the reading materials may be in the user's native language and a target language or languages which the user desires to learn. In one embodiment, the bilingual reading materials may include illustrations, such as in a comic book form to create comic stories. Comic book stories, for example, may be geared towards children learners. Providing stories in book form (non-illustrated) may also be useful. Non-illustrated stories may be tailored for adults.

To furthermore augment language learning, the reading materials may be provided in printed form as well as being displayed on the user device. For example, the reading materials may be printed prior or supplied by the supplier of the App as part of a complete course. The printed material serves as an external source for language learning.

A user may select a story for viewing in multiple languages. For example, the user has the options to view the story displayed and presented though a voice in either the native or the target language. The user may also practice reading the story aloud. For example, the microphone of the user device may record the reading of the story by the user. In addition, a user can practice reading aloud words, phrases and/or sentences introduced in the story through voice exercises. For example, the user can practice reading aloud voice exercises in the target language. The microphone of the user device may also record the reading of the voice exercises by the user. The recording may be kept as a record. The recording, for example, of the voice exercise, may be analyzed by a speech analysis module (not shown) to provide feedback on the language fluency and pronunciation of the user.

The reading module may also contain games which are configured for learning languages. For example, the games may be a form of written word and voice matching games, such as matching a recorded word played in a target language with a written word from a group of written words. Other types of games may also be useful.

As for the video module, in one embodiment, it contains videos which are used for drawing along while learning languages. The videos may be live-streamed or recorded videos. In one embodiment, the videos include casual and scripted conversations or presentations which may or may not include readings of books or comic books. The videos may be used to learn how selected words in the target language are pronounced as well as written, as well as how to represent the word in simple illustrated form. The videos also may contain a segment where the artist draws suggestions from the learners, and the learner learns what the suggestions are called in both native and target languages. The videos are conducted in both native and target languages and the languages are used interchangeably throughout the broadcast session. Other configurations of the videos may also be useful.

The resource module contains resources to support parents and teachers, such as lesson plans, activity sheets, rubrics, STEAM extensions, quizzes, feature articles as well as other information such as useful news, tips or analysis that may arise from time to time. For example, lesson plans can be tailored to the user. Lesson plans can be tailored for a prescribed period of time, with selected stories and videos, including live-streamed videos, to incrementally increase language knowledge while making it enjoyable. Quizzes can be used to indicate the level of knowledge learned by of the user.

The mobile App, as described, provides interactive versions of the stories and games. The components of the platform can be used individually or in concert to increase language learning efficacy. The platform is configured to provide enjoyment in language learning, boosting both language abilities as well as creative skills.

The present language learning system strengthens language learning through the interplay between the mutually reinforcing effects of illustrated stories (comic stories), translanguaging, drawing video sessions and reading aloud.

With respect to the illustrated stories, they provide cognitive hooks through multimodal techniques, such as through visuals, sound effects, actions, and expressions. Furthermore, illustrated comic stories form more positive and stronger emotional associations with the content, particularly with children.

Regarding translanguaging, learners' pre-existing knowledge provides maps of meaning for the target language. This provides support and scaffolding so that the target language does not feel overwhelming. Translanguaging imparts greater metalinguistic awareness because of the deliberate comparisons between the languages. In addition, the greater sense of “play” between languages leads to greater ownership of the target language.

As for video drawing sessions, they are designed to help users, for example, learners, remember, express and record what they have learned. In addition, the video drawing sessions help learners organize their thoughts, increase their imagination and even to formulate arguments. The video drawings sessions also facilitate learners to take risks and find their own voice, particularly with live streaming video sessions. In addition, it helps the learner to practice focusing and pay attention to detail, such as what is being streamed.

Reading aloud helps learners to internalize how phrasing, pace, inflection, tone and pitch work to express meaning and character. In addition, vocabulary can be increased by reading the story in context as well as increased enjoyment and motivation to speak the target language.

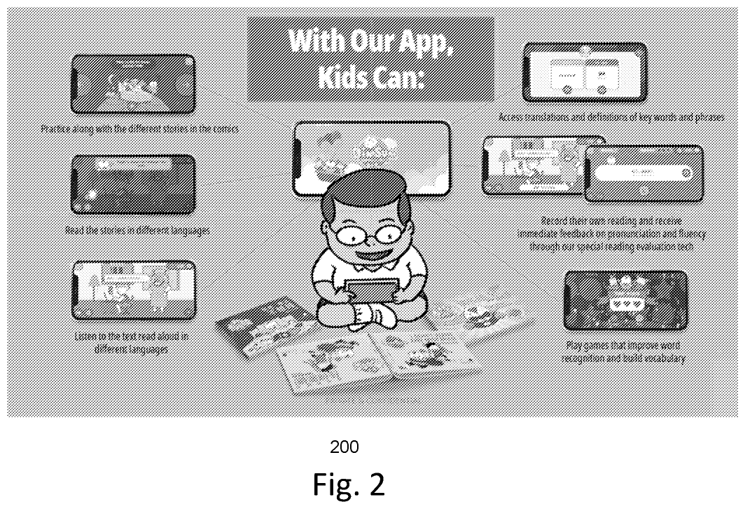

FIG. 2 illustrates an embodiment of a framework 200 involving an App of the language learning system. For example, a user can access information, interactive learning content and functionalities within the system by initiating an App on a user device. The user device is, for example, associated with a learner with registered access to digitized content within the reading module, video module and/or resource module of the platform.

As shown, the user can access digitized content within the reading module of the platform from the App. For example, the user can launch a language program managed by the reading module and participate in activities within the program. Such activities encourage the user to read and listen to a story in different languages to improve the user's vocabulary knowledge. The user may also practice reading the story aloud. Additionally, the user can also practice exercising voice expressions in the reading module. For example, the microphone of the user device may record the user's reading of voice exercises and the user's pronunciations are evaluated via a speech analysis module. The reading module, in one embodiment, is also configured to provide translation and definition support for users during the activities.

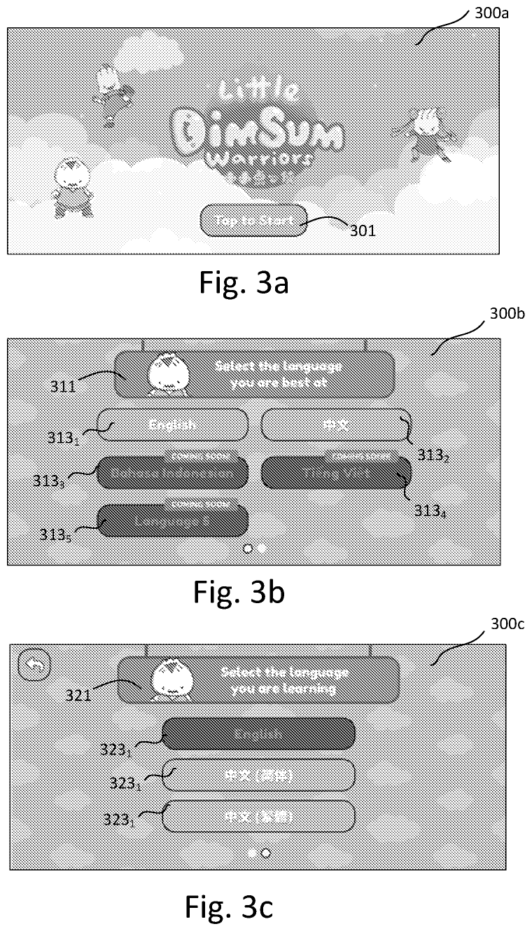

FIGS. 3a-3c show various exemplary pages or views of the platform displayed on a user or learner's user device through a user interface (UI) of the App. For example, the user initiates an App running on the user device and logs in as a registered learner user to access information, learning content and functionalities within the system.

Referring to FIG. 3a, an embodiment of an overview page 300a is shown. The overview page may be displayed, for example, after logging into the platform. As shown, the overview page includes a start button 301. Clicking on the start button causes the platform to direct the user to a next appropriate page, for example, a user settings page of the platform.

FIG. 3b shows an embodiment of a user settings page or view 300b of the platform. The user settings page, for example, is a user native language settings page. The user native language settings page, for example, determines an interface language of the platform. For example, textual details such as help information, instructions, and alerts are displayed using a native language set in the native language settings page.

In one embodiment, the user native language settings page includes an instruction panel 311 and language selectors 3131₁₋₅. The instruction panel contains instructions to guide the user in defining the user settings. For example, the instruction panel may prompt the user to select a user native language. Preferably, the user native language is a native or home language, or a language most frequently used by the user or one which the user is most fluent. This allows the user to easily navigate through the various functions and applications of the platform.

As shown, language selectors for different languages are provided for the user to select. For example, the language selectors include an English selector, a Chinese selector, a Bahasa Indonesian selector, a Vietnamese selector. Different languages may be used to indicate the different language selectors. For example, each language selector is indicated according to its associated language. Alternatively, the language selectors may be indicated using a universal language such as English. Other configurations of the language selectors may also be possible. In addition, other forms of displaying language choices such as a dropdown menu of languages may also be useful.

To set a user native language, the user may click any one of the language selectors provided. In some cases, some of the language selectors may not be available for selection. For example, language selectors 313₃₋₅ represent upcoming languages that are not yet available. Alternatively, depending on the account or registration information of the user, the user may not have access to certain available languages. Such language selectors may be color-coded in, for example, black to indicate its inaccessibility.

FIG. 3c shows an embodiment of another user settings page or view 300c of the platform. The user settings page, for example, is a user target language settings page. For example, the user target language settings page is displayed after the user sets a user native language in the user native language setting page.

As shown, the instruction panel 321 may prompt the user to select a user target language. The user target language, for example, is a language which the user wants to learn. Similar to the user native language settings page, language selectors 323₁₋₃ for different languages are also displayed on the user target language settings page. The user can click any of the language selectors to set a user target language. However, it is understood that the user target language and the user native language cannot be the same. For example, the user cannot select a language selector indicating a same language type as the user native language.

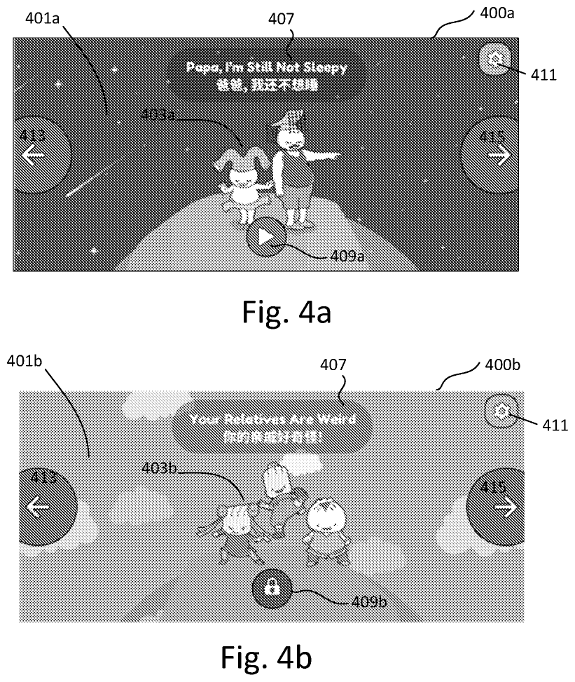

FIGS. 4a-4b show various program section views 400a-b of a program overview page within the platform. In one embodiment, the program overview page includes program section views configured to display program selectors for different programs. For example, each program section view displays one program selector. To view another program selector on a different program section view, the user may click a previous button or a next button provided by a current program section view.

Referring to FIG. 4a, a program section view 400a displays a program selector as shown. The program section view provides information about a course or program managed by a reading module of the platform. For example, the program section view displays a background of the program. For example, the background includes an environment 401a in which the program will be conducted in as well as the avatars 403a employed. A title 407 of the program may also be included in the program section view. As shown, the title is indicated in the preset user native and target languages. Using 1 preset language for the title may also be possible.

A user may select the program by clicking the program selector 409a which directs the user to, for example, a program homepage of the selected program. Alternatively, the user can select a previous 413 or next button 415 to browse through other program selectors.

The program section view further includes other action buttons such as a settings button 411. For example, the settings button redirects the user to the user settings page. Other configurations for the program section view may also be possible.

FIG. 4b shows another program section view 400b of the program overview page. As shown, the program section view displays another program selector 409b in a different environment 401b with different avatars 403b. In this case, the program is locked to the user. The program selector 409b is not accessible to the user. For example, depending on the account or registration information of the user, the user may not have access to certain programs or courses on the platform.

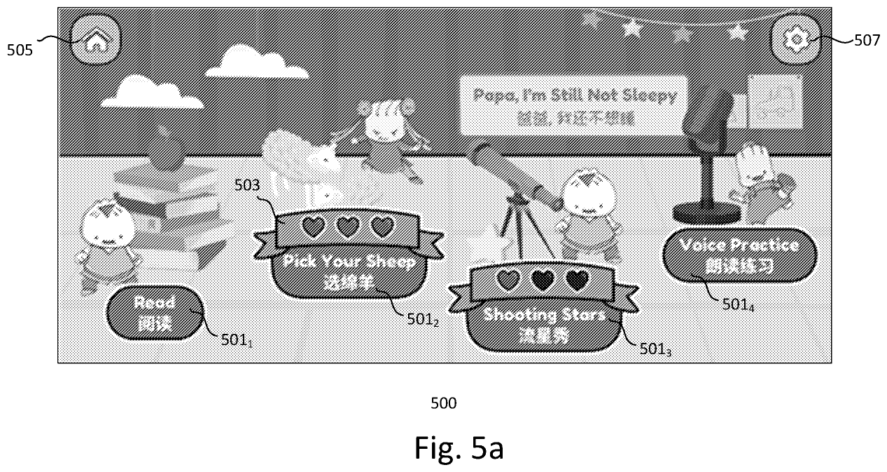

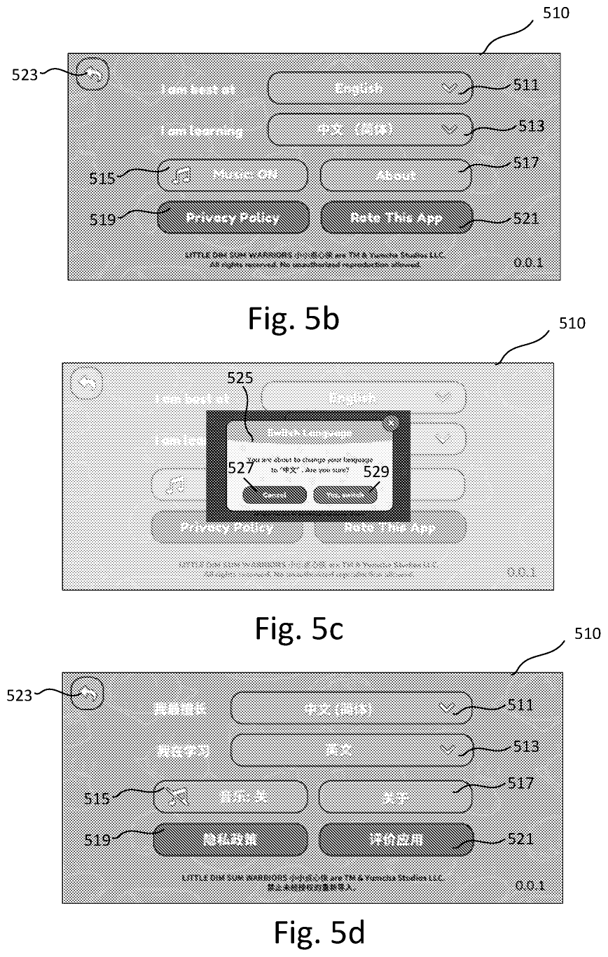

FIG. 5a shows an embodiment of a program homepage 500 of a selected program on the platform. The selected program, for example, is a language program. The program homepage, as shown, includes a background environment with avatars. The environment and the avatars, for example, share a common theme along with other views or pages related to the program.

In one embodiment, the program homepage includes activity selectors or icons 501₁₋₄ for directing the users to training and assessment activities within the program. The training activities may include a storytelling session and a voice practice session while the assessment activities may include games, quizzes or tests. Providing other activities in the program may also be useful. Furthermore, it is understood that the activities may include any number of storytelling sessions, voice practice sessions and/or other sessions or activities.

As shown, different names are assigned to the various activity icons to easily identify an activity associated with each activity icon. For example, a read icon 501₁ is associated to a storytelling session and a voice practice icon 501₄ is linked to a voice practice session. Activity icons may also be named after titles of the games that they are associated with. A user may click on, for example, a pick your sheep icon 5012 and/or a shooting stars icon 501₃ to participate in the games within the program. The names of the activity icons are indicated in 2 languages, for example, the preset user native and target languages. Naming the activity selectors using 1 preset language may also be possible.

Activity icons associated with the assessment activities may further include a score display 503. For example, the score display indicates the most recent performance results of the user in a particular game.

The program homepage may also include action buttons. For example, the action buttons may include a program home button 505 and a program settings 507 button. A user can click on the program home button to return to the program overview page to view other programs. As for the program settings button, it directs the user to a program settings page. Other configurations for the program homepage may also be possible.

FIGS. 5b-5d show various exemplary pages or views of the platform in different stages of modifying program settings of a selected language program.

Referring to FIG. 5b, a program settings page or view 510 of the platform is shown. The program settings page is configured to allow a user to modify settings such as language and sounds settings across the platform. For example, the settings defined in the program settings page are global settings and apply to functions or applications outside the selected program including other programs on the platform.

In one embodiment, the program settings page includes a program language select section 511 and a program target language select section 513. The program language select section allows the user to choose a main language in which the program is conducted. For example, textual details such as help information, instructions, and alerts displayed by the program during training will be in a chosen program language. As for the program target language select section, it defines a program target language that the user is learning within the selected program.

The program language select section 511 includes a drop-down menu of languages for the user to select. In one embodiment, the drop-down menu of languages is limited to a list of user native and target languages preset in the user settings page. Similarly, the program target language select section 513 also includes a drop-down menu of preset user native and target languages. The user has the freedom to toggle between using the preset user native and target language as either the program language or the program target language. Other configurations to set the program language and/or program target language may also be possible.

A music select section 515 for controlling sound settings may also be provided by the program settings page. For example, the music select section is a switch button for the user to interchange between music on and music off functions.

To return to the program homepage, the user can click a previous button 523 provided by the program settings page. Additional action buttons for other functions may also be employed. For example, the program settings page may include action buttons to direct users to pages providing program or platform information, or to provide feedback about the App. For example, action buttons such as an about button 517, a privacy policy button 519 and a Rate this App button 521.

As shown in FIG. 5c, after a user changes his selection of program language and program target language, the program settings page 510 will display an alert box 525 with a text prompt to the user. For example, the user is alerted that the settings are about to be changed. The user may choose to not proceed with the new changes by clicking a cancel button 527 in the alert box. This will direct the user back to the program settings page with the previous or original settings.

Alternatively, the user can choose to continue with the new changes by selecting a Yes button 529 in the alert box. In such cases, the user is directed back to the program settings page displaying the new settings. For example, as shown in FIG. 5d, the program language is changed and the program settings page 510 is now displayed using a different program language. Other configurations for the program settings page may also be possible.

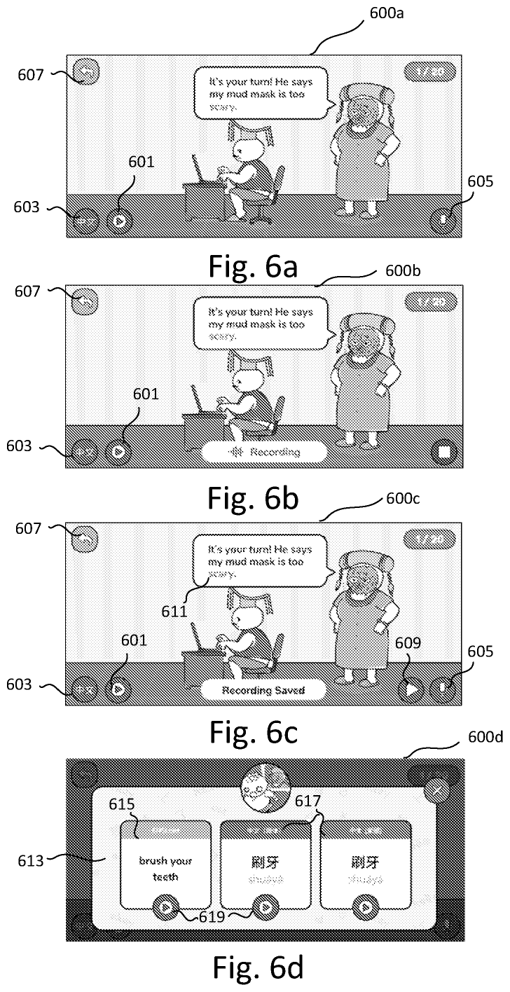

FIGS. 6a-6d show various scenario views 600a-d of a storytelling session in a selected language program. Referring to FIG. 6a, a scenario view 600a of a storytelling session is shown. The scenario view, for example, is loaded after the user selects the read icon on the program homepage. The scenario view displays a scenario of a storytelling session. The scenario, for example, belongs to a sequence of scenarios connected to form a complete story.

The user can view the story in multiple languages. For example, during a storytelling session, the story can be displayed and presented though a voice in either the program language or the program target language. In one embodiment, the scenarios are displayed in a comic book format. For example, the scenarios include 2D scenes with text, pictures, actions, expressions and sounds to make the storytelling session more interesting. As a user can better relate to interactive content, the user is able to more effectively remember the learning content taught in the storytelling session. Providing other types of content may also be possible.

As shown in FIG. 6a, the scenario includes a 2D environment with avatars having expressions and actions. A text content may be displayed as conversational dialogues between avatars in the scenario. In one embodiment, the scenario provides a reading function that recites text content in the dialogues of the scenario. For example, a user can select a read button 601 which causes the scenario to present an avatar's voice. In addition, the user can toggle between 2 languages for the avatar's voice by selecting a language option 603. Preferably, the language of the avatar's voice is interchangeable between the program language and the program target language. In one embodiment, the scenario is further configured with other functions. For example, the scenario also provides a record function, and a dictionary function. Other configurations or functions may also be employed for the scenario.

The record function of the scenario facilitates to record the user's voice. For example, as shown in FIGS. 6b-6c, the user's voice is recorded when the user clicks a record button 605. The recorded voice is saved for the user to playback and listen at any time. For example, when the recording finishes at FIG. 6c, the user can listen to the recorded voice by selecting a playback button 609. In one embodiment, only a most recent recording by the user is saved. For example, a new recording overwrites the previous recording. Other configurations for the record function may also be useful.

As for the dictionary function, it facilitates to provide translation as well as an explanation of text content in the scenario. For example, referring to FIG. 6d, the user can click a color-coded word 611 to display a dictionary section view 613. The dictionary section view, in one embodiment, includes section boxes containing the color-coded word in different languages. For example, the section box includes a program language section box 617 and a target program language section 615 box. By displaying different languages alongside each other, the user can better understand the meaning of a word in learning language by associating it to a word indicated in the user's familiarized language. The user can also listen to pronunciations of the words in the different languages by clicking read buttons 619 associated with each section box. Furthermore, the dictionary section view may also display illustrative explanations of the words in pictures or images. Other configurations of the dictionary section view may also be useful.

The user may suspend the storytelling session at any point in the training process. For example, the user can exit the storytelling session before reaching an ending scenario of the storytelling session. In such cases, the user can click a return button 607 which causes the user to be directed back to the program homepage.

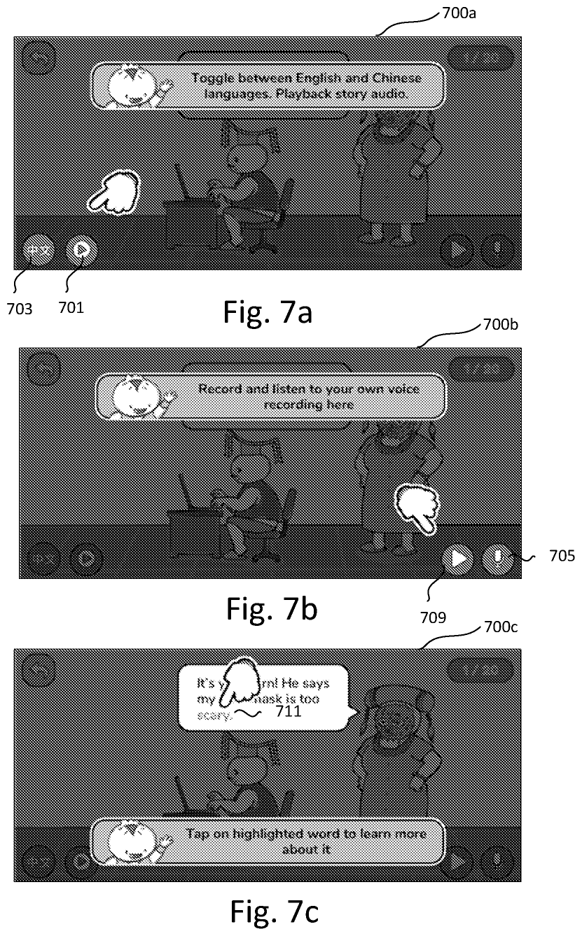

FIGS. 7a-7c show various scenario views 700a-c of the storytelling session. The scenarios in the scenario views are similar to those described in FIGS. 6a-6d and similar elements will not be described.

As shown, a user may hover over various options or action buttons provided in the scenarios of the storytelling session to display help instructions associated to each option. For example, as shown in FIGS. 7a-7b, the user may hover over the read button 701, the language option 703, the record button 705 or the playback button 709 to view help instructions on how to use the functions associated to the various options or buttons. In addition, as seen in FIG. 7c, the user may also hover words indicated in red 711 to view instructions on how to activate the dictionary function. Other configurations to display help instructions may also be possible.

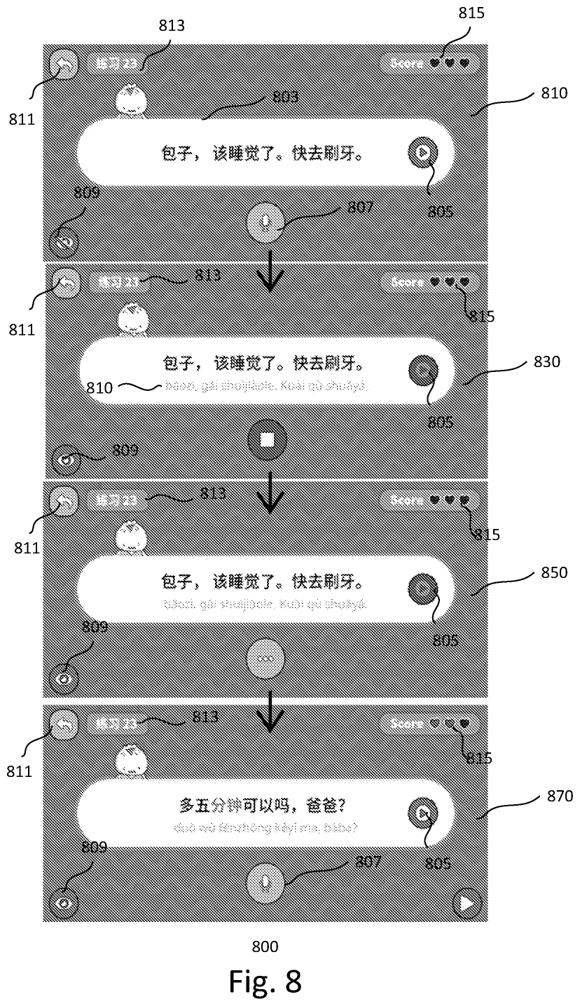

FIG. 8 shows a process flow 800 of a voice practice session in the selected program. The process flow, for example, starts at 810. For example, at 810, a voice practice session commences.

As shown, an activity page of a voice practice session is loaded when the voice practice session commences. For example, the user selects the voice practice icon provided by the program homepage to commence the voice practice session. In one embodiment, a voice practice session includes voice exercises with phrases or sentences selected from the stories in the program to train the user's speech capabilities. For example, the voice exercises allow the user to practice reading aloud and familiarize with the stress pattern, fluency and rhythm of a language. The user is trained to improve his or her phrasing, pace, inflection, tone and pitch.

In one embodiment, the activity page of the voice practice session is based on a voice exercise in a voice practice session. The activity page includes an exercise panel 803 with written phrases or sentences. In addition, the phrases or sentences may be presented through a voice. The voice, for example, is a trainer voice. The trainer voice presents an ideal or accurate recitation of the written phrases or sentences in the exercise panel. The user can choose to listen to the trainer voice by selecting a read button 805 provided in the exercise panel. This allows the user to get familiar with sounds and pronunciations of the language by passive listening. The language in which the voice exercise is conducted may be according to selections by the user. For example, the language of the written phrases or sentences as well as the trainer voice are based on the program target language selected by the user in the program settings page.

The activity page includes details of the voice practice session of the selected program. The details may include, for example, title 813 of the voice exercise associated to the activity page, as well as a score 815 indicating the user's last recorded performance in the voice exercise.

The activity page may further include various options or action buttons to provide different functionalities or support during the voice exercise. In one embodiment, the various options include a record button 807 for recording a user's voice and a view pronunciation option 809 to display pronunciation symbols. For example, the user may select the view pronunciation button to toggle between on and off options. As shown, the option to view pronunciation is turned off. Action buttons such as a previous 811 and a next button (not shown) to navigate through different voice exercises in the voice practice session may also be provided.

A recording function is activated in 830. For example, the user selects the record button 807 to start a recording session. The recording captures a voice of the user reciting the voice exercise. The view pronunciation option 809 may be turned on to guide the user during the recording. For example, when the view pronunciation option is turned on, the exercise panel displays pronunciation symbols 810 below each word in the exercise panel. This guides the user in pronouncing the phrases or sentences. Users who are viewing the words for the first time or are unable to recognize the words will find this extremely useful. Moreover, when a user gets more familiar with the words of the language, the user can choose to turn off the view pronunciation option.

Once the user completes recording a voice exercise, the speech analysis module of the platform proceeds to analyze the recorded voice exercise in 850. For example, the recording session is saved and stored in a temporary storage of the platform or an external server for subsequent retrieval. The speech analysis module automatically retrieves and starts analysis of the recorded voice exercise. At this stage, the user is not allowed to start another recording session.

The speech analysis module, in one embodiment, employs a voice recognition software to identify whether words are correctly recited by the user in the recorded voice exercise. Correct words may be identified based on accuracy of words pronounced. The software may be from third party developers, such as Chivox. Other types of voice recognition software may also be employed.

At 870, the analysis finishes, and the results are displayed. For example, the phrases or sentences displayed on the exercise panel are color-coded to identify words that are recited wrongly. As shown, words that are recited wrongly are indicated in red. A score indicating the user's performance in the voice exercise is also displayed. The user can choose to start a new recording session of the current voice exercise for evaluation or proceed to the next voice exercise. For example, the user can practice on a same voice exercise until a satisfactory performance or score is achieved. In this way, the user can practice avoiding the mistakes identified from previous recording sessions.

Once the user is ready to move on to the next voice exercise, the user may select a next button which directs the user to a next activity page with another voice exercise. Alternatively, the user can click the previous button 811 to return to a previous activity page or a voice practice overview page or even back to the program homepage. It is understood that the user may suspend the voice practice session at any point in the training process. For example, the user need not complete all the voice exercises at one go. Instead, the user may return back to the last voice exercise at any time to complete training of the voice practice session. Alternatively, the user may choose to retrain any of the completed voice exercises.

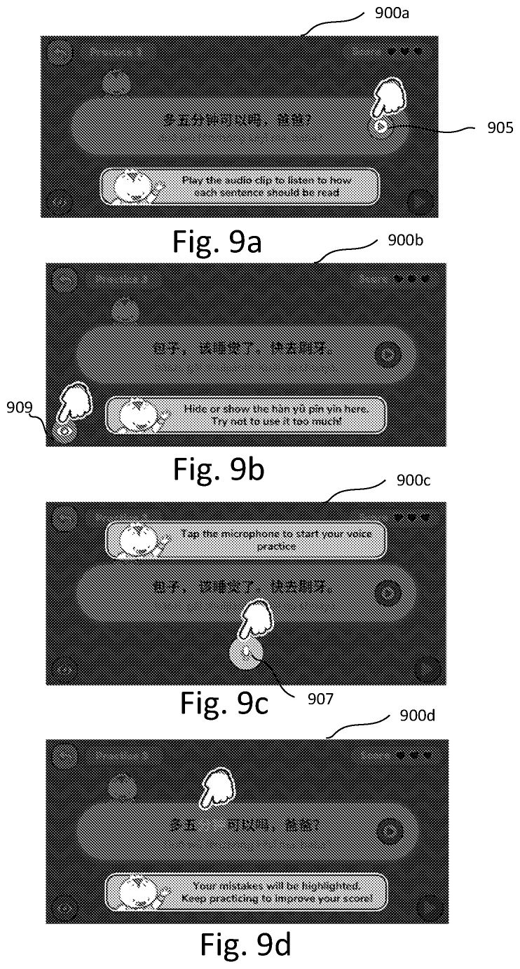

FIGS. 9a-9d show various views 900a-d of another activity page of the voice practice session. The activity page is similar to the activity page described in FIG. 8 and similar elements will not be described.

As shown, a user may hover over various options or action buttons provided by the activity page to display help instructions associated to each option. For example, as shown in FIGS. 9a-9c, the user may hover over the read button 905, the view pronunciation option 909, and the record button 907 to view instructions on how to use the functions associated to the various options or buttons. In addition, as seen in FIG. 9d, the user may also hover words indicated in red after analysis of a recorded voice session to view an explanation for the display of color-coded words. Other configurations to display help instructions may also be possible.

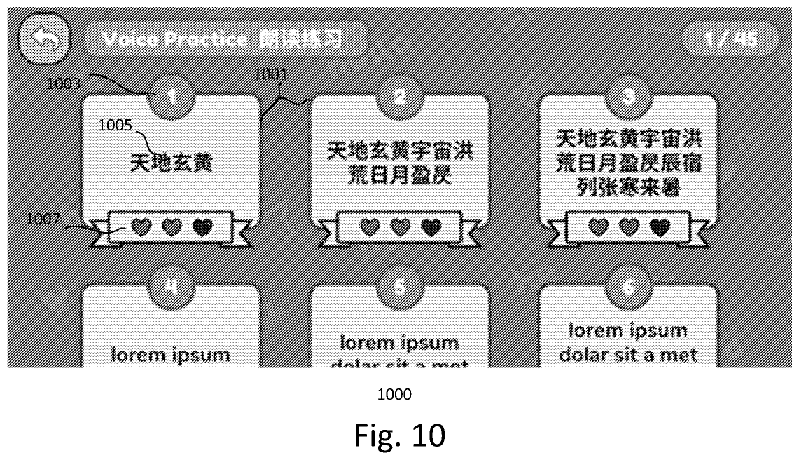

FIG. 10 shows a voice practice section view page 1000 of the voice practice session. As shown, the voice practice section view page displays a list of voice exercises for the user to select. The voice practice section view page is displayed, for example, at the start of the voice exercise session or when the user completes a voice exercise. Alternatively, the user can be directed to the voice practice section view page by selecting the previous button provided by an activity page of the voice practice session.

In one embodiment, the voice practice section view page includes voice exercise icons 1001 for different voice exercises. Clicking a voice exercise icon directs the user to the selected voice exercise. A voice exercise icon contains details about a voice exercise within the voice training session. For example, the details include a name or title 1003 of the voice exercise, phrases or sentences 1005 for practice in the voice exercise, and a score 1007 indicating user's performance in the voice exercise.

As shown, the voice exercises are named in a numbering sequence. For example, the voice exercises are numbered. Employing other names or titles for the voice exercises may also be useful. In addition, while scores of the user are shown to be displayed on the voice exercise icons, it is understood that in the case that a user has not yet trained in a voice exercise, no score will be presented for a voice exercise icon representing that voice exercise.

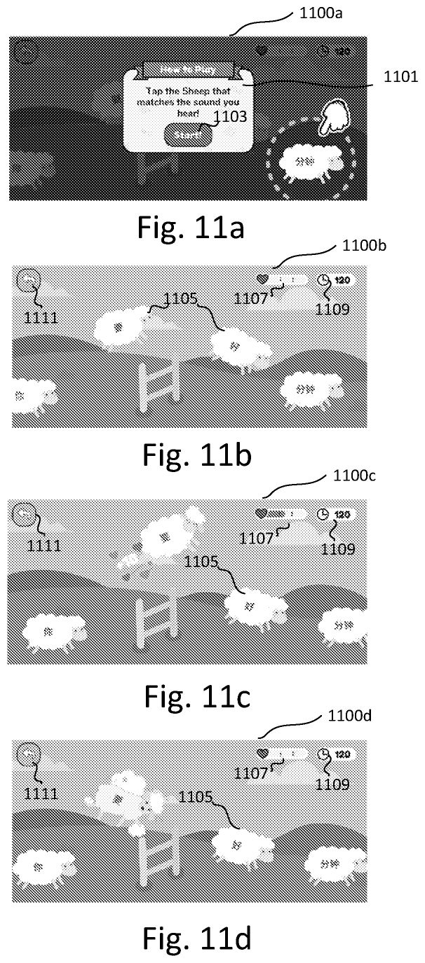

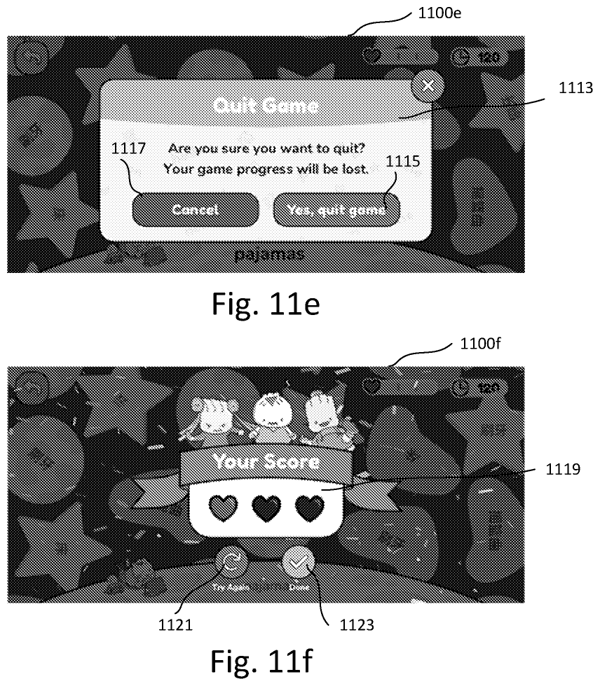

FIGS. 11a-11f show various scenario views 1100a-f of a game session in the selected program. The game, for example, is a first game provided in the selected program. The first game is configured to train users to connect pronunciations or sounds of words to written words of a language. For example, a user is trained to find matching pairs of sounds and written words.

Referring to FIG. 11a, a scenario view 1100a of the first game session is shown. The scenario view displays, for example, a starting scenario of a plurality of scenarios of the first game. The starting scenario may be displayed, for example, after the first game is loaded. For example, the user selects the pick your sheep icon in the program homepage which causes the first game to load.

The starting scenario provides game instructions 1101 on how to play the first game. For example, the game instructions may be presented in text and/or images. Other forms of presenting the game instructions may also be useful. The user may select a start button 1103 to start training in the first game. For example, the user is directed to a next scenario of the first game after selecting the start button.

FIG. 11b shows another scenario view 1100b of the first game session. The scenario view, for example, displays a training scenario when the user starts a training session of the first game.

As shown, a training scenario displays a 2D scene including objects with actions, expressions and sounds. In one embodiment, the objects include image objects with written words. For example, the image objects serve as word choices 1105 for the user to select. Each word choice contains 1 written word or multiple written words. At the same time, the training scenario also presents a query word through a voice. In one embodiment, only 1 query word is presented at a time. The voice, for example, pronounces a query word which corresponds to written word(s) of a specific word choice.

The user has to select a word choice having written word(s) that match(es) the presented query word. In one embodiment, the query word is presented in the same language as the word choices. For example, both the query word and the word choices are presented in a program target language determined by the user in the program settings page. This trains the user to associate words to their corresponding pronunciation sounds of a language. Alternatively, the query word may be presented in a language different from the word choices. For example, the query word is presented in a program language while the word choices are presented in a program target language or vice versa. Other configurations for the game may also be employed.

In response to a word choice selected by the user, the training scenario may present actions, expressions and/or sounds. For example, as seen in FIGS. 11c and 11d, different actions, expressions and/or sounds are displayed when a user taps on a word choice that correctly or incorrectly corresponds to the presented query word.

In one embodiment, the training scenario displays a score 1107 of the user in real-time. For example, as shown in FIG. 11c, the score is updated in real-time as the user progresses through the training session of the first game. The training scenario may also contain other details of the training session. Such details may include, for example, a remaining time to finish the game. For example, as shown in FIGS. 11b-d, a time panel 1109 indicating a remaining time is displayed on the training scenario. Providing other information may also be possible.

It is understood that the user may suspend the training session at any point in the training process. For example, the user may select a return button 1111 provided by the training scenario to exit the current game. In such cases, a confirm exit prompt 1113 may be displayed on the training scenario as shown in FIG. 11e. The user may choose to exit the game by selecting the yes button 1115 which directs the user to the program homepage. Alternatively, the user may select the cancel button 1117 to resume the training session.

Once the user completes a training session of the game, a score 1119 is displayed on an ending scenario of the first game as shown in FIG. 11f. Options to exit the game or retry the game may also be displayed for the user to select. For example, the ending scenario may include a try again option 1121 and a done option 1123. Selecting the done option directs the user back to the program homepage. Alternatively, the user may choose to retrain in the current game by clicking the try again option to start a new training session. Other configurations for the scenario views or the game may also be employed.

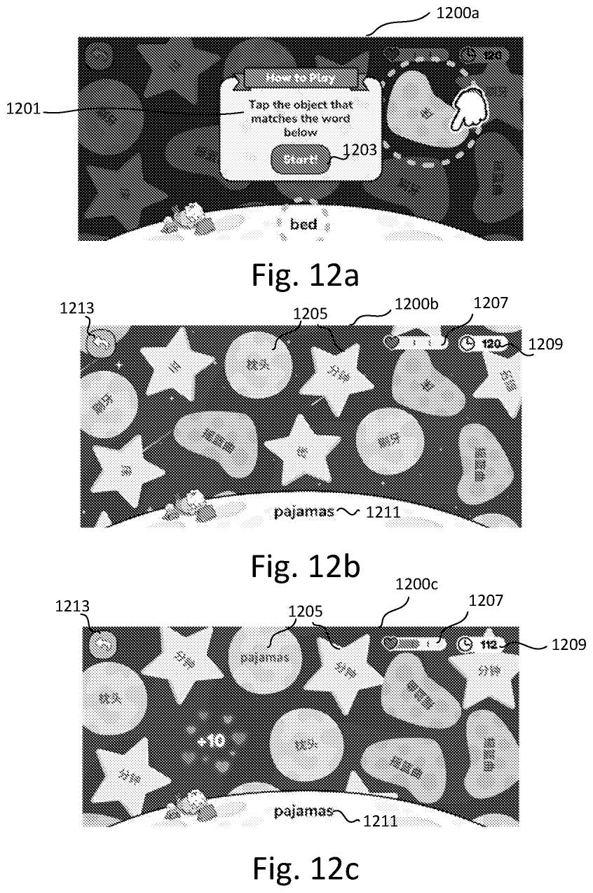

FIGS. 12a-12c show various scenario views 1200a-c of another game session in the selected program. The game, for example, is a second game provided in the selected program. The second game is configured to train users to connect written words of two different languages. For example, a user is trained to find matching pairs of written words having same meaning but in different languages.

Referring to FIG. 12a, a scenario view 1200a of the second game session is shown. The scenario view, for example, displays a starting scenario of a plurality of scenarios of the second game. The starting scenario may be displayed, for example, after the second game is loaded. For example, the user selects the shooting stars icon provided by the program homepage which causes the second game to load.

The starting scenario provides game instructions 1201 on how to play the second game. For example, the game instructions may be presented in text and/or images. Other forms of presenting the game instructions may also be useful. The user may select the start button 1203 to start training in the second game. For example, the user is directed to a next scenario of the second game after selecting the start button.

FIG. 12b shows another scenario view 1200b of the second game session. The scenario view, for example, displays a training scenario when the user starts a training session of the game.

As shown, the training scenario displays a 2D scene including objects with actions, expressions and sounds. The objects, in one embodiment, include image objects with written words. For example, the image objects serve as word choices 1205 for the user to select. Each word choice contains 1 written word or multiple written words. At the same time, the scenario also presents a written query word 1211. The written query word, in one embodiment, corresponds to a specific word choice. For example, the query word and its corresponding word choice share a same meaning.

The user has to select, from the word choices, one word choice containing a written word or words having a same meaning as the written query word. In one embodiment, the written query word is presented in a language different from that of the word choices. For example, the written query word is presented in a program language while the word choices are presented in a program target language or vice versa. This allows the user to better relate to words in a learning language (for example, a program target language) since the user is able to map them against a language which the user is familiar (for example, a program language). Other configurations for the game may also be employed.

In response to a word choice selected by the user, the training scenario may present actions, expressions and/or sounds. For example, when a user selects a word choice, the selected word choice is read out through a voice. In addition, as seen in FIG. 12c, actions, expressions and/or sounds may be displayed when a user taps on a word choice that correctly corresponds to the query word.

In one embodiment, the training scenario view displays a score 1207 of the user in real-time. For example, as shown in FIG. 12c, the score is updated in real-time as the user progresses through the training session of the second game. The training scenario may also contain other details of the training session. Such details may include, for example, a remaining time to finish the game. For example, as shown in FIGS. 12b-12c, a time panel 1209 indicating a remaining time is displayed on the training scenario. Providing other information may also be possible.

As discussed, it is understood that the user may suspend the training session at any point in the training process. For example, the user may select a return button 1213 provided by the training scenario to exit the current game. In such cases, a confirm exit prompt may be displayed on the training scenario. The user may choose to continue exiting the game by selecting the yes button which directs the user to the program homepage. Alternatively, the user may select the cancel button to resume the training session.

Once the user completes a training session of the game, a score is displayed on an ending scenario of the second game. Options to exit the game or retry the game may also be displayed for the user to select. Such options may include a try again option and a done option. Selecting the done option directs the user back to the program homepage. Alternatively, the user may choose to retrain in the current game by clicking the try again option to start a new training session. Other configurations for the scenario views or the game may also be employed.

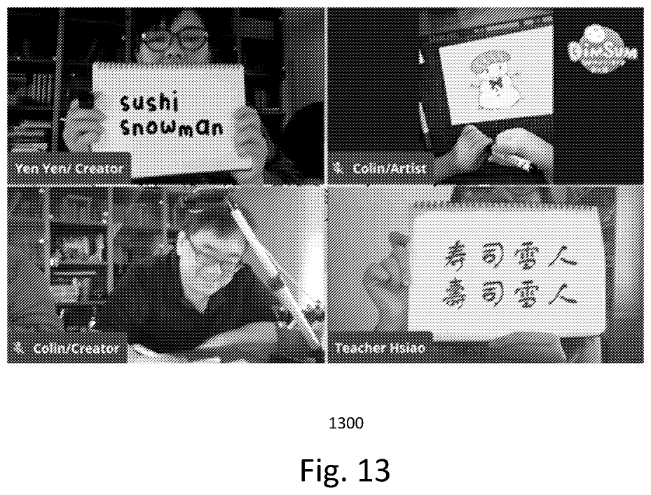

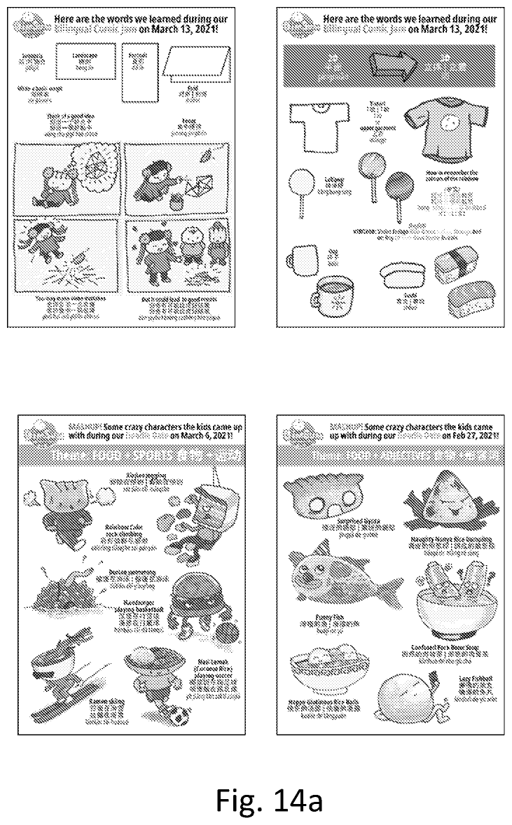

FIG. 13 shows a video session 1300 published on the platform. In one embodiment, videos are managed by a video module of the platform. The videos may be live-streamed or recorded videos. In one embodiment, the videos may be hosted by a third-party video hosting provider, such as Vimeo, and published on the platform for user to access through the video module. Employing other hosting solutions or applications for the video sessions may also be useful. The user may access videos published on the platform through a browser.

In one embodiment, the video module of the platform broadcasts a stream of a live video session on an interface screen of each user device of a plurality of learners attending the live event remotely. Furthermore, the live video session can be conducted remotely by a plurality of trainers situated at different sites. As shown, a group of trainers is conducting a live workshop and broadcasting the live workshop to a plurality of learners who are in remote attendance. The live workshop is associated with a program that the learners are enrolled in. The live workshop, for example, is a drawing workshop which focuses on concepts or objectives associated to a program enrolled by the learners. The learners, for example, belong to a group of learners who are fluent in a same native language and are learning a same target language.

The drawing workshop, for example, is conducted in bilingual languages. For example, the languages employed in the workshop include a target language (learning language) and a native language which the learners are all familiar or fluent in.

The drawing workshop may be hosted by artist trainers and language trainers. For example, the artist trainers use ideas from the program to create drawings and the language trainers translate the drawings into words written in a target language as well as a primary language. The learners may also provide drawing ideas or suggestions to the artist trainer during the live event session. For example, the learners can communicate with the trainers through text messages. For example, the video module includes a messaging module to receive and display feedback, such as text messages, entered by the learners during the live video session. At the same time, learners are also encouraged to create their own drawings or illustrations.

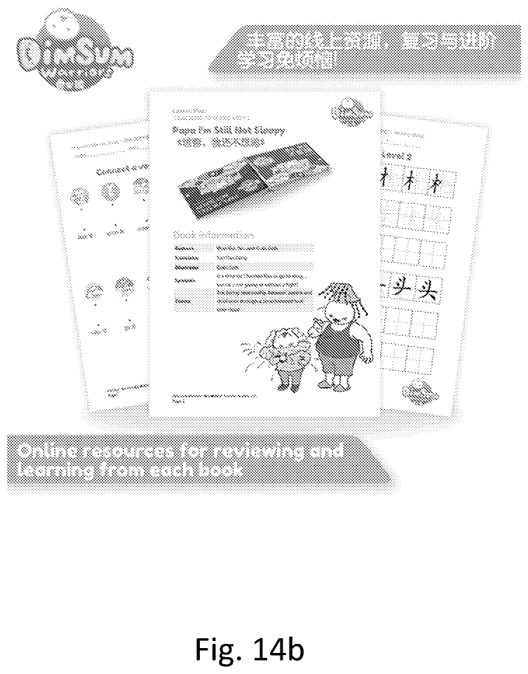

After the live video session, the trainer can upload resources associated with the live video session on the platform for the learners to retrieve and/or download. For example, as shown in FIG. 14a, the resources may be documents containing images and/or text content related to topics discussed during the live video session. The documents may include exercises and/or quizzes. Other types of resources may also be published on the platform for learners to access.

Apart from resources relating to video sessions, other relevant resources independent of the video sessions may also be published on the platform. For example, as shown in FIG. 14b, the relevant resources may include supporting resources for learners such as quizzes, exercise or activity sheets, feature articles as well as teaching resources for trainers such as lesson plans. Such resources may be available for retrieval by users accessing the platform via the web browser. For example, a user can download the relevant resources from the web browser and view them as online forms or printables.

The embodiments of the computer or computer devices (e.g., client devices and server computers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. As used herein, the term “processor” should be understood as encompassing any of the foregoing hardware, either singly or in combination. Further, portions of each of the client devices and each of the server computers described herein do not necessarily have to be implemented in the same manner.

At least one embodiment of the present disclosure relates to an apparatus for performing the operations/functionalities described herein. This apparatus may comprise special purpose computers/processors, or a general-purpose computer, selectively activated or reconfigured by a computer program stored on a non-transitory computer-readable storage medium that can be accessed by the computer.

All or a portion of the embodiments of the disclosure can take the form of a computer program product accessible from, for example, a non-transitory computer usable or computer-readable medium. The computer program, when executed, can carry out any of the respective operations, methods, functionalities and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, ROM, RAM, EPROM (erasable programmable read-only memory), EEPROM (electrically erasable programmable read-only memory), magnetic or optical cards, ASICs, or any type of media suitable for tangibly containing, storing, communicating, or transporting electronic instructions.

Also, the particular division of functionality between the various system components described herein is merely exemplary, and not mandatory; functions performed by a single system component may instead be performed by multiple components, and functions performed by multiple components may instead performed by a single component. Operations that are described as being performed by a single processor, computer, or device can be distributed across a number of different processors, computers or devices. Similarly, operations that are described as being performed by different processors, computers, or devices can, in some cases, be performed by a single processor, computer or device.

Unless specifically stated otherwise, it is appreciated that throughout the description, discussions utilizing terms such as, for example, “processing”, “computing”, “calculating”, “displaying”, “determining”, “establishing”, “analyzing”, “checking”, or the like, refer to operation(s) and/or process(es) of a computer, a computing platform, a computing system, or other electronic computing device, that manipulate and/or transform data represented as physical (e.g., electronic) quantities within the computer's memories and/or registers into other data similarly represented as physical quantities within the computer's memories and/or registers or other information storage medium that may store instructions to perform operations and/or processes.

The present disclosure may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

1. A method for language learning on a learning platform comprising:
providing the learning platform comprising
a backend system executed on a server, the backend system includes
a reading module, the reading module is configured to manage programs including providing language programs, wherein the language programs employ translanguaging techniques for training a target language, and
a frontend system, wherein the frontend system is executed on a user device and includes a user interface to access various modules of the backend system;
training of a language program selected by a user accessing the reading module through the user device, wherein the selected language program is presented based on a user native language input and a user target language input; and
assessing performance of the user during training of the selected language program including performing analytics using a speech analysis module of the backend system to provide feedback on language fluency and pronunciations of the user.

2. The method of claim 1 wherein training of the selected language program comprises training in a story session, a voice practice session and/or a gaming session of the selected language program.

3. The method of claim 2, wherein training in the story session includes
viewing a story displayed and presented though a voice based on the user native language input or the user target language input, wherein the story is a comic story;
recording a reading of the story by the user; and
accessing translation and dictionary functions provided by the reading module to view translations and explanations in both user native language and user target language.

4. The method of claim 2, wherein training in the voice practice session includes
selecting a voice exercise from a plurality of voice exercises for a user to practice reading aloud, wherein each voice exercise includes words displayed and presented though a voice based on the user target language input;
recording a reading of the voice exercise by the user; and
analyzing the recorded reading of the voice exercise using the speech analysis module to provide feedback on language fluency and pronunciations of the user.

5. The method of claim 1, wherein the backend system further comprises a video module configured to manage videos for viewing by the user on the user device, wherein the videos include live-streamed videos configured to broadcast content related to one or more programs provided by the reading module.

6. The method of claim 1, wherein the backend system further comprises a resource module configured to store learning resources and teaching resources for users to retrieve.

7. A learning platform for language learning comprising:
a backend system executed on a server, the backend system includes
a reading module, the reading module is configured to
manage programs including providing language programs, the language programs employ translanguaging techniques for training a target language, wherein the language programs are presented based on a user native language input and a user target language input, and
a speech analysis module, the speech analysis module is configured to assess language fluency and pronunciations during training of the language programs; and
a frontend system, wherein the frontend system is executed on a user device and includes a user interface to access various modules of the backend system.

8. The learning platform of claim 7 wherein the reading module is further configured to facilitate training of the language programs, wherein training of each language program comprises
training in a story session including
viewing a story displayed and presented though a voice based on the user native language input or the user target language input, wherein the story is a comic story,
recording a reading of the story by the user, and
accessing translation and dictionary functions provided by the reading module to view translations and explanations in both user native language and user target language, and
training in a voice practice session including
selecting a voice exercise from a plurality of voice exercises for a user to practice reading aloud, wherein each voice exercise includes words displayed and presented though a voice based on the user target language input,
recording a reading of the voice exercise by the user, and
analyzing the recorded reading of the voice exercise using the speech analysis module to provide feedback on language fluency and pronunciations of the user, and
training in a gaming session.

9. The learning platform of claim 7, wherein the backend system further comprises
a video module configured to manage videos for viewing on the user device, wherein the videos include live-streamed videos configured to broadcast content related to one or more programs provided by the reading module; and
a resource module configured to store learning resources and teaching resources for users to retrieve.

10. A method for multi-modality language learning comprising:
selecting a target language and a native language by a user;
providing the user with a selection of translanguage reading documents configured with the target language and the native language;
selecting by the user a selected reading document for reading;
displaying the selected reading document for the user to read aloud into a microphone for recording a recorded reading by the user of the selected reading document; and
assessing a performance of the user based on the recorded reading using speech analysis to provide feedback on language fluency and pronunciation of the user.
